(19) United States
(12) Patent Application Publication
(10) Pub. No.: US 2003/0115348 A1
(43) Pub. Date: Jun. 19, 2003

(54) Push type information service system and method for supplying information through the same

(75) Inventor: Kazunori Ohashi, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/166,624

(22) Filed: Jun. 12, 2002

(30) Foreign Application Priority Data
Jun. 13, 2001 (JP) 2001-178808

(51) Int. Cl. G06F 15/16

(52) U.S. Cl. 709/230

(57) ABSTRACT

The model of internet protocols presently available includes four layers, i.e., physical layer, network layer, transport layer and application layer; an application control layer is inserted between the transport layer and the application layer for controlling service usable at each combination of address assigned to a server and port number so that the server can offer push-type service to clients with the assistance of the application control layer.

### FIELD OF THE INVENTION

This invention relates to information service technologies and, more particularly, to a push type information service system and a method for supplying information to clients.

### DESCRIPTION OF THE RELATED ART

Users presently access pieces of information to be required through the world wide web, which is usually abbreviated as “WWW”. The world wide web is the most popular information system, and a large number of web sites are incorporated in the world wide web. The web site is a set of linked web pages stored on a web server. When a user requests the web server to access a web page stored therein through the browser, the web server responds to the request so as to permit the browser to fetch the web page expressed in the hypertext transfer protocol. The web page contains text, graphics, sound and video. The hypertext transfer protocol is preferable for the multimedia so that a large number of users access the web pages expressed in the hypertext transfer protocol.

Portals are a kind of web site, and the internet service providers, who are abbreviated as ISPs, and the application service providers, who are abbreviated as ASPs, offer the portals to users on the world wide web. The users search the portals for pieces of information to be required. Nevertheless, the web server is not always the best program for the service providers. It is desirable for the service providers to prompt the users to select an application program appropriate to the piece of information to be offered. However, it is presently impossible to specify the application programs used in the clients.

For this reason, the service providers supply pieces of information to users through the links in the web sites or the facilities contained in Java. However, the pieces of information requested by the users are not always matched with the pieces of information offered by the providers. Moreover, the pieces of multimedia information sometimes imperfectly reach a user due to user's interface program improper to produce visual images, sound or video.

In this situation, the service providers think it impossible automatically to supply pieces of information to the users without any action on the user side. If the service providers can offer push type information supply services to their users much easier than now, the quality and quantity of the information supply services are improved, and the service cost is reduced.

FIG. 1 shows the current model of the internet protocols. The current model includes four layers, i.e., the physical layer 61, network layer 62, transport layer 63 and application layer 64. The physical layer 61 is the lowest, and the application layer 64 is the highest. The network layer 62 and the transport layer 63 are inserted between the lowest physical layer 61 and the highest application layer 64. The physical layer 62, network layer 62, transport layer 63 and application layer 64 form a protocol stack, which is established in a server computer S as well as a client computer C. A user and a service provider are communicable with one another through the protocol stacks in the server/client computers S and C.

When the service provider offers certain service to the user, the request for the certain service steps down in the protocol stack in the server computer S. Namely, the request for the certain service is relayed from the highest application layer 64 through the transport layer 63 and the network layer 62 to the lowest physical layer 61. A signal representative of the certain service is propagated through the communication network to the client computer C. Then, the certain service step up in the protocol stack in the client computer C, i.e., it is relayed from the lowest physical layer 61 through the network layer 62 and the transport layer 63 to the highest application layer 64. The certain service is offered to the user. Thus, the application layer 64 of the server computer S is finally connected to the application layer 64 of the client computer C, and the provider offers the service to the user. The service is specified by using the port number in the transport layer, and the application is determined by the combination of an IP address in the network layer 62 and the port number in the transport layer 63.

As will be understood, the sort of service to be offered by the server S is dependent on the port in the transport layer 63 to be opened in the current model of the internet protocols. In order to request the server S to offer the service, the client C is to be connected to the IP address and port number through which the server S offers the service. In order words, only the pull-type communication is available for the information supply service.

A preliminary investigation is required for the information supply service. The user preliminary checks the guidebook or the application such as the web server installed in the server computer S for the sorts of service offered by the server S. When the user finds a certain sort of service to be required, the user drives the client computer C for receiving the service. However, it is impossible to determine whether or not a client computer C can enjoy the service to be offered. In other words, the client computer C is a black box from the standpoint of the server computer S, and the server computer S is also a black box from the standpoint of the client computer C. In this situation, the providers can not offer the service suitable for the users, and the users irritate the providers. The current model of the internet protocols merely offers the pull-type service through the IP address and port number.

### SUMMARY OF THE INVENTION

It is therefore an important object of the present invention to provide an information service system, through which a provider offers a push-type service to clients.

It is also an important object of the present invention to provide a method for offering a push-type service to clients.

To accomplish the object, the present invention proposes to manage sorts of service to be offered at each combination of port number and address in an application control layer inserted into a model of protocols.

In accordance with one aspect of the present invention, there is provided a n information supply system comprising a hardware including at least one server assigned an address, at least one client and a communication network connected to the at least one server and the at least one client and a protocol model including a physical layer, a network layer on the physical layer, a transport layer on the network layer having plural ports selectively assigned to sorts of push-type service, an application control layer on the transport layer managing applications for the sorts of push-type service at the address and an application layer on the application control layer maintaining pieces of server information and pieces of client information and managing the applications and established in the hardware for communication between the at least one server and the at least one client, and the physical layer, the network layer, the transport layer and the application layer have definitions identical with those given to corresponding layers in an internet protocol model so that the sorts of push-type services are transferred between the at least one server and the application layer and between the application layer and the client.

In accordance with another aspect of the present invention, there is provided a method for supplying a push-type service comprising the steps of a) preparing a tool for communication between at least one user and at least one provider assigned an address through a protocol model including a physical layer, a network layer on the physical layer, a transport layer on the network layer having plural ports selectively assigned to sorts of service, an application control layer on the transport layer managing applications for the sorts of service at the address and maintaining pieces of server information and pieces of client information and an application layer on the application control layer maintaining the applications so as to offer an interface to the at least one user and the at least one provider, b) fetching one of the pieces of server information representative of sorts of push-type service assigned certain ports from the application control layer by the at least one user, c) selecting at least one sort of push-type service by the at least one user, d) requesting the at least one provider to offer the at least one sort of push-type service, e) maintaining one of the pieces of client information representative of the at lest one sort of push-type service in the application control layer, f) establishing a certain kind of environment for the at least one sort of push-type service in a client computer of the user and a server computer of the provider, and g) starting the at least one sort of push-type service.

### BRIEF DESCRIPTION OF THE DRAWINGS

The features and advantages of the push type information service system and the method will be more clearly understood from the following description taken in conjunction with the accompanying drawings, in which

FIG. 1 is a view showing the current model of the internet protocols,

FIG. 2 is a view showing a model of protocols established in an information service system according to the present invention,

FIG. 3A is a view showing communication between a server and a client through the model of protocols according to the present invention,

FIG. 3B is a view showing the communication between the server and the client through the prior art internet model of protocols,

FIG. 4 is a view showing contents of server information and contents of client information,

FIG. 5 is a flowchart showing essential steps of a method for requesting a push-type information supply to a provider, and

FIG. 6 is a flowchart showing essential steps of a method for proposing the push-type information supply to a user.

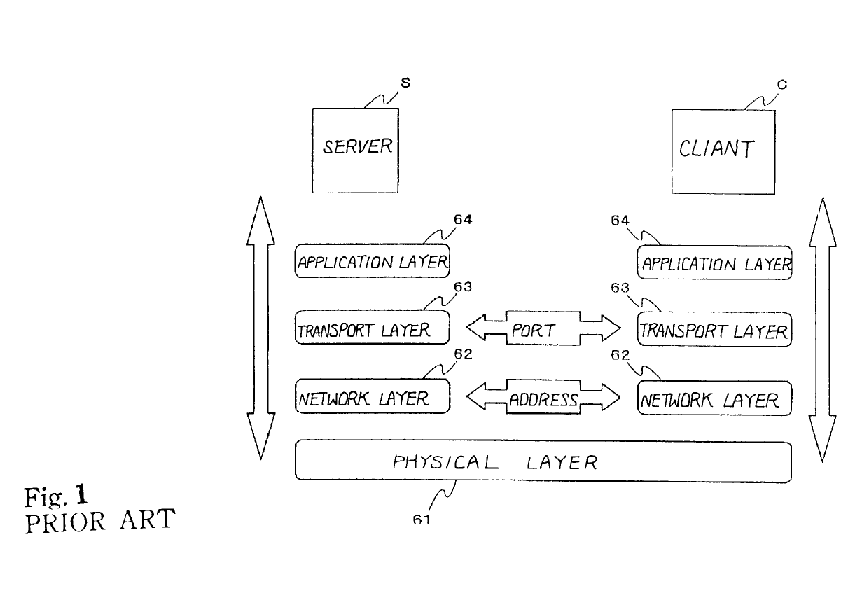

### DESCRIPTION OF THE PREFERRED EMBODIMENTS

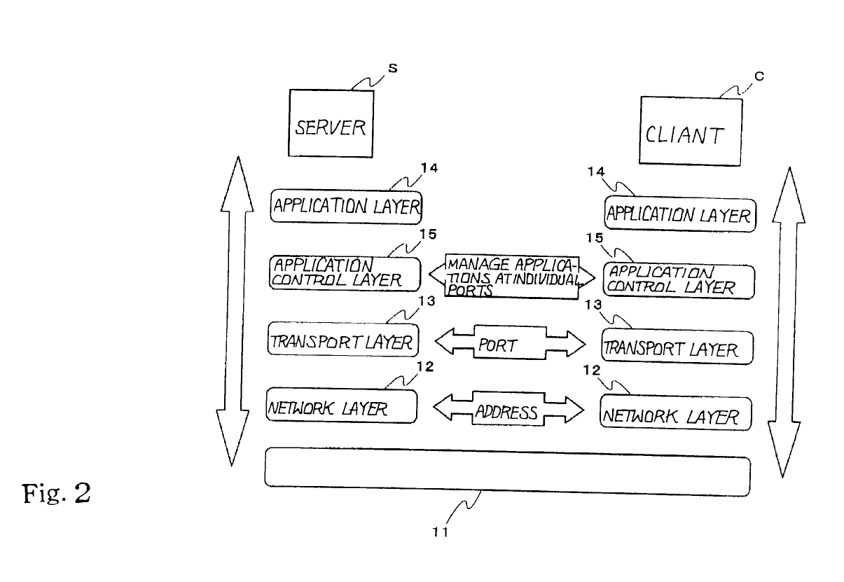

Referring to FIG. 2 of the drawings, a model of protocols established in an information service system embodying the present invention has five layers 11, 12, 13, 14 and 15, i.e., a physical layer 11, a network layer 12, a transport layer 13, an application layer 14 and an application control layer 15. Comparing the model of protocols with the prior art model of protocols, the application control layer 14 is inserted between the transport layer 13 and the application layer 14 in each of the server S and the client C. The hardware of the information service system includes the server computer, the client computer and a communication network such as, for example, the internet. The model of protocols is established in the hardware.

As described in conjunction with the prior art model of internet protocols, the server S and client C can not confirm sorts of service to be offered and the sorts of service to be available. When a provider wants to offer a push-type information supply service, the server S only offers the service to the client only through the applications already known. The server S informs the client C of the sorts of service to be offers through the model of protocols according to the present invention, and the client C informs the server S of the sorts of service to be required. Because, the sorts of service to be offered and the sorts of service to be required are transmitted between the server S and the client C through the application control layer 15. The black boxes are opened to the server S and client C. Thus, the service is offered from the server S and enjoyed by the client C through the most appropriate applications at high efficiency.

The protocol used in the application control layer 15 is referred to as “application control protocol”. There is not any limit set to the application control protocol in so far as it manages pieces of control data information representative of the service to be offered by the server S and the service to be received by the client C.

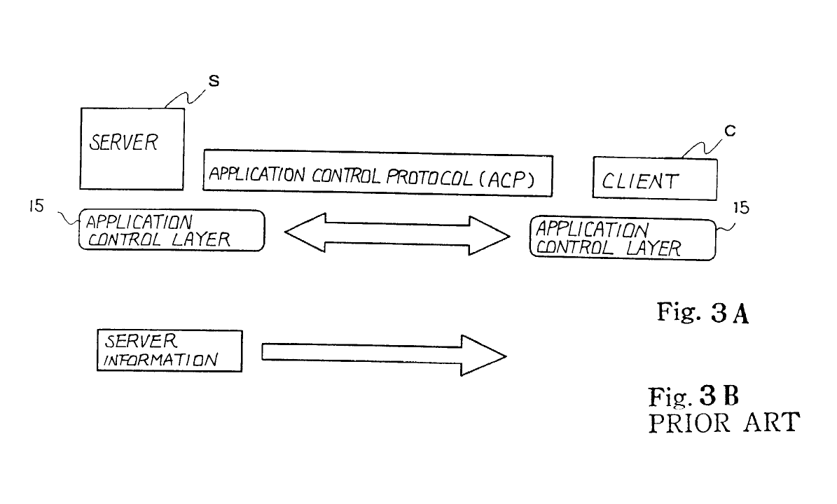

FIGS. 3A and 3B illustrate communication between the server S and the client C. In the model of protocols according to the present invention, pieces of server information and pieces of client information are expressed in the application control protocol, and are stored in the application control layer 15. The protocol in the application control layer 15 makes the sorts of service to be offered by the server S and the sorts of service to be received by the client C clear. The pieces of server information and pieces of client information are transferred through the application control layer 15 between the server S and the client C as shown in FIG. 3A. Thus, the information transmission through the model of protocols according to the present invention is bidirectional. As described hereinbefore, the information transmission is unidirectional in the prior art model as shown in FIG. 3B. Thus, the application control layer 15 makes the information transmission between the server S and the client C bi-directional.

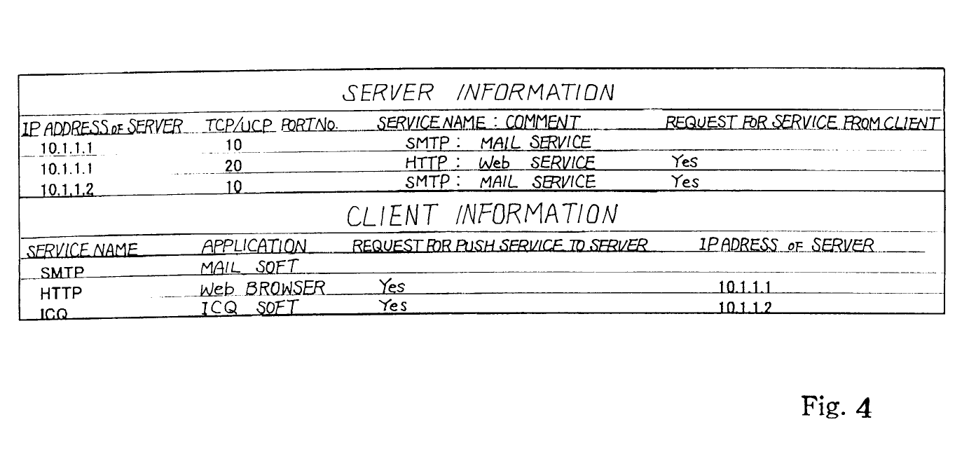

FIG. 4 illustrates contents in the server information and contents in the client information. These are examples, and do not set any limit to the server information and client information according to the present invention. The server information is obtained from the server S, and is fetched by means of a tool designed for the application control layer 15 or an application program already installed in the web site. The server S maintains the server information representative of sorts of service to be offered to the users, and supplies the server information to the users. IP address is assigned to each server S, and a sort of service is obtained from the port. The sorts of service to be required are specified by the tag “yes”. In this instance, the client C has requested the Web service and the mail service to the server S. For this reason, the server S tags “yes” to the “HTTP: web service” and “SMTP: mail service”. The web service “HTTP” is specified by the combination of IP address “10.1.1.1 ” and TCP/UCP port No “20”. The mail service “SMTP” is specified by the combination of IP address “10.1.1.2 ” and TCP/UCP port No. “10”. However, the main service “SMTP” at address “10.1.1.1 ” and port No. “10 ” has not been requested.

The client C determines the contents of the client information, and maintains them therein. The “REQUEST FOR PUSH-SERVICE TO SERVER” is only possible from the server S whom the client C relies on. It is desirable from the viewpoint to guard the privacy that the above-described information is maintained and managed by only the client C.

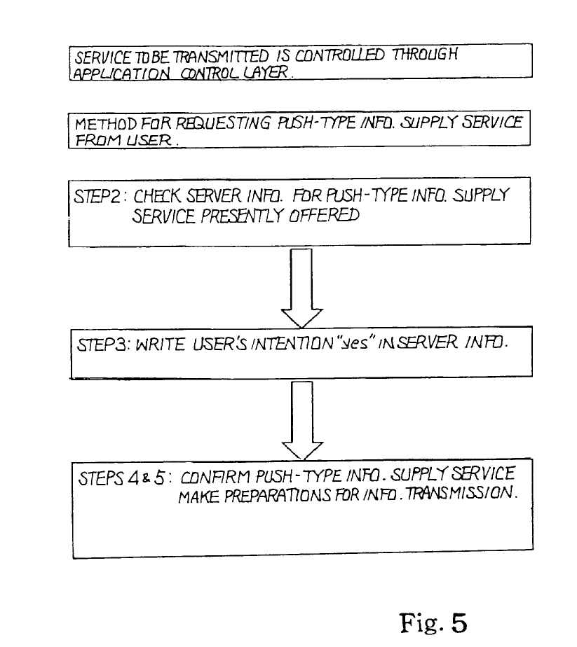

Description is made on a method for requesting a push-type information supply service to a provider with reference to FIG. 5. The service to be transmitted is controlled through the application control layer 15, and the method for requesting a push-type information supply service starts at step 1 where the user obtains the server information from a reliable provider through the internet. Otherwise, a tool for obtaining the server information is installed in the application control layer 15 so as to fetch the server information.

STEP2: When the user's computer is connected to the provider's computer through the internet, the user checks the server information to see what sort of push-type information supply service is offered. The user confirms the sorts of push-type information supply service presently offered by the provider.

If the user does not find the push-type information supply service to be required by the user in the server information, the user terminates the communication to the provider.

On the other hand, when the user finds the push-type information supply service to be required in the server information, the user proceeds to step 3.

STEP3: The user requests the provider to start the push-type information supply service to the provider. The user's intention “yes” is written in the server information.

STEP 4: In order to confirm that the provider surely offers the push-type information supply service, the user connects the application control layer 15 of his or her computer to the application layer 15 of the provider's computer, and the user asks if the provider surely offers the push-type information supply service.

If it is impossible presently to offer the push-type information supply service to the user, the user withdraws the request.

On the other hand, when the provider is ready to start the push-type information supply service for the user, the provider accepts the request for the push-type information supply service. Then, the user and provider enter the relation between the server and the client, and proceeds to step 5.

STEP 5: The client and server communicate with one another through the application control layers 15, and make preparations for the information transmission. Since only the pull-type information service is only available for the client in the prior art internet model, it is possible to determine whether the server S or client C initiates the information supply service depending upon the application.

Upon completion of the preparations, the client C and server S get ready for the push-type information supply service.

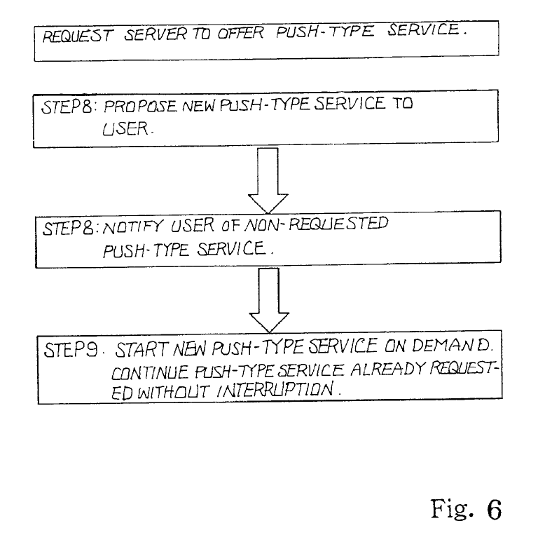

FIG. 6 shows a method for proposing a push-type information supply service to a user

STEP 6: A tool or application for establishing a certain kind of environmnent was installed The application has been already activated in the communication between the server S and the client C.

STEP 7: The server S fetches the client information from the client C by using the program expressed in the application control protocol. If the client information is incomplete, the user is promptly requested to complete the client information, and, thereafter, the client information is transmitted from the client C to the server S.

The server S checks the client information to see whether or not all sorts of possible push-type service have been already requested by the user. If the answer is affirmative, the server S terminates the work with the positive answer.

STEP 8: On the other hand, the server S still has several sorts of push-type service which the user has not been requested, yet. Then, answer is given negative, and the server S transmits the pieces of server information representative of the non-requested push-type service. The client C notifies the user of the pieces of server information representative of the non-requested push-type service.

STEP 9: If the user wants a new push-type service, he or she requests the server S to start the new push-type service, and the request for the new push-type service is written in the server/client information. Accordingly, the application establishes the new environment in the application control layer 15. The server S starts the new sort of push-type service. The sorts of push-type service already requested are continuously offered to the client S without interruption.

The connection for the push-type service is in the application control layer 15, which is over the transport layer 13 for TCP/UCP. When the server S offers the push-type service to the client C, the server S confirms it through the application control layer 15. When the client C is notified of the push-type service through the application control layer 15, the client C activates the application so as to receive the push-type service. Thus, the push-type service does not interfere with the usual behavior of the internet application. This means that the applications already installed for the internet are available together with the newly installed applications for the application control layer 15.

As will be appreciated from the foregoing description, the push-type service is offered to clients by inserting only the application control layer 15 into the prior art model of internet protocols. Although the internet protocol model is modified a little, the push-type service is offered to clients.

It is possible to communicate through the applications already installed for the push-type service. This means that any new system is not required on the world wide web using Java.

It is possible to offer a wide variety of service regardless of the application. New information supply service is possible through an application different from the well-known application.

The security is maintained in so far as the client accepts the service from the reliable server.

It is possible to let the users know whether or not the sorts of service have been already offered through the internet.

Although a particular embodiment of the present invention has been shown and described, it will be apparent to those skilled in the art that various changes and modifications may be made without departing from the spirit and scope of the present invention.

What is claimed is:

1. An information supply system comprising:
a hardware including at least one server assigned an address, at least one client and a communication network connected to said at least one server and said at least one client; and
a protocol model including a physical layer, a network layer on said physical layer, a transport layer on said network layer having plural ports selectively assigned to sorts of push-type service, an application control layer on said transport layer managing applications for said sorts of push-type service at said address and maintaining pieces of server information and pieces of client information and an application layer on said application control layer for maintaining said applications, and established in said hardware for communication between said at least one server and said at least one client, said physical layer, said network layer, said transport layer and said application layer having definitions identical with those given to corresponding layers in an internet protocol model so that said sorts of push-type services are transferred between said at least one server and said application layer and between said application layer and said client.

2. The information service system as set forth in claim 1, in which said pieces of server information are representative of said address assigned to said at least one server, port numbers respectively assigned to said plural ports, said sorts of push-type service offered at said plural ports and user's positive or negative intention of at said at least one client toward said sorts of push-type service, and said pieces of client information are representative of said sorts of push-type service, the applications used for said sorts of push-type service, said user's positive or negative intention toward said sorts of push-type service and said address at which at least one of said sorts of push-type service is offered to said at least one client.

3. The information service system as set forth in claim 2, in which a browser for a world wide web, a program for an e-mail and an ICQ program are applications selected from the group of said applications.

4. A method for supplying a push-type service, comprising the steps of:
a) preparing a tool for communication between at least one user and at least one provider assigned an address through a protocol model including a physical layer, a network layer on said physical layer, a transport layer on said network layer having plural ports selectively assigned to sorts of service, an application control layer on said transport layer managing applications for said sorts of service at said address and maintaining pieces of server information and pieces of client information and an application layer on said application control layer maintaining said applications so as to offer an interface to said at least one user and said at least one provider;
b) fetching one of said pieces of server information representative of sorts of push-type service assigned certain ports from said application control layer by said at least one user;
c) selecting at least one sort of push-type service by said at least one user;
d) requesting said at least one provider to offer said at least one sort of push-type service;
e) maintaining one of said pieces of client information representative of said at lest one sort of push-type service in said application control layer,
f) establishing a certain kind of environment for said at least one sort of push-type service in a client computer of said user and a server computer of said provider; and
g) starting said at least one sort of push-type service.

5. The method as set forth in claim 4, in which others of said pieces of server information are representative of said address assigned to said server computer, port numbers respectively assigned to said plural ports, relation between said sorts of push-type service and said plural ports and user's positive or negative intention of at said client computer toward said sorts of push-type service, and others of said pieces of client information are representative of the applications used for said sorts of push-type service, said user's positive or negative intention toward said sorts of push-type service and said address at which at least one sort of push-type service is offered to said at least one client.

6. The method as set forth in claim 5, in which a browser for a world wide web, a program for an e-mail and an ICQ program are applications selected from the group of said applications.

7. The method as set forth in claim 5, further comprising the steps of
h) fetching said piece of client information representative of said at least one sort of push-type service by said server computer,
i) checking said pieces of server information to see whether or not all the sorts of push-type service presently possible have bee already offered to said client computer,
j) asking whether or not said user requests said server computer to offer another sort of push-type service when the answer at said step i) is given negative,
k) adding a piece of client information representative of the positive intention of said user to said application control layer when the answer at said step j) is positive, and
l) starting said another sort of push-type service.
